(19) United States
(12) Patent Application Publication
(10) Pub. No.: US 2018/0365591 A1
(43) Pub. Date: Dec. 20, 2018

(54) ASSESSMENT RESULT DETERMINATION BASED ON PREDICTIVE ANALYTICS OR MACHINE LEARNING

(71) Applicant: International Business Machines Corporation, Armonk, NY (US)

(72) Inventors: Fabrizio Cucci, Dublin (IE); Spyros Kotoulas, Dublin (IE); Vanessa Lopez, Dublin (IE); Marco Luca Sbodio, Dublin (IE)

(21) Appl. No.: 15/842,506

(22) Filed: Dec. 14, 2017

Related U.S. Application Data
(63) Continuation of application No. 15/626,917, filed on Jun. 19, 2017.

(51) Int. Cl. G06N 99/00; G06F 17/30; G06N 5/02

(52) U.S. Cl. CPC G06N 99/005; G06F 17/30657; G06F 19/322; G06N 5/02

(57) ABSTRACT

Techniques facilitating assessment result determination based on predictive analytics and/or machine learning are provided. In one example, a computer-implemented method can comprise matching, by a system operatively coupled to a processor, input data retained in a knowledge source database to an inquiry included in a received questionnaire. The input data can be associated with a target entity. The computer-implemented method can also comprise generating, by the system, a response to the inquiry based on the input data retained in the knowledge source database and a feature value that specifies a defined form of the response. The response can be based on an applicability of the input data to the target entity. Further, generating the response can be based on machine learning applied to information retained in the knowledge source database.

### BACKGROUND

The subject disclosure relates to assessment result determination, and more specifically, assessment result determination based on predictive analytics and/or machine learning.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatus and/or computer program products that facilitate assessment result determination are described.

According to an embodiment, a computer-implemented method can comprise matching, by a system operatively coupled to a processor, input data retained in a knowledge source database to an inquiry included in a received questionnaire. The input data can be associated with a target entity. The computer-implemented method can also comprise generating, by the system, a response to the inquiry based on the input data retained in the knowledge source database and a feature value that specifies a defined form of the response. The response can be based on an applicability of the input data to the target entity. Further, generating the response can be based on machine learning applied to information retained in the knowledge source database. In an embodiment, matching the input data retained in the knowledge source database to the feature value can comprise semantically expanding a defined answer to a previous query. According to a specific example, the target entity can be a patient, the knowledge source database can be a medical record, and the received questionnaire can be a medical questionnaire.

According to an embodiment, a system can comprise a memory that stores computer executable components and a processor that executes computer executable components stored in the memory. The computer executable components can comprise a matching component that compares input data from a knowledge source database to at least one question in a query. The input data can be associated with a target entity. The executable components can also comprise an evaluation component that determines an applicability of the input data to the at least one question based on a feature value. The feature value can comprise a defined response format. Further, the executable components can comprise a machine learning component that generates a response to the at least one question. The response can be based on the applicability of the input data to the target entity and conformance to the feature value that defines a format of the response. According to an embodiment, the computer executable components can also comprise a selection component that facilitates a selection of the query from one or more alternative queries based on a condition of the target entity. The condition can be a subject matter of the query.

According to another embodiment, a computer program product for facilitating assessment result determination can comprise a computer readable storage medium having program instructions embodied therewith. The program instructions are executable by a processing component. The program instructions can cause the processing component to evaluate, by the processing component, questions of one or more questions against information retained in a knowledge source database. The knowledge source database can comprise data related to a target entity. The program instructions can also cause the processing component to match the information retained in the knowledge source database to one or more features defined for responses to the one or more questions. Further, the program instructions can cause the processing component to determine respective responses to questions of the one or more questions based on the information retained in the knowledge source database and based on feature values that indicate defined forms of the responses. In some implementations, the determination can be based on machine learning applied to the information retained in the knowledge source database.

### DESCRIPTION OF THE DRAWINGS

FIG. 1 illustrates a block diagram of an example, non-limiting, system that facilitates intelligent automatic completion of information in response to one or more questions of an assessment in accordance with one or more embodiments described herein.

FIG. 2 illustrates a block diagram of an example, non-limiting, system that facilitates automatic completion of one or more questionnaires based on predictive analysis in accordance with one or more embodiments described herein.

FIG. 3 illustrates a block diagram of an example, non-limiting, system that facilitates an interpretable recommendation for customized outputs in accordance with one or more embodiments described herein.

FIG. 4 illustrates a block diagram of an example, non-limiting, system that facilitates an interpretable recommendation for customized outputs in accordance with one or more embodiments described herein.

FIG. 5 illustrates a block diagram of an example, non-limiting, flow diagram of an architecture that facilitates determination of assessment results in accordance with one or more embodiments described herein.

FIG. 6 illustrates a block diagram of an example, non-limiting, flow diagram of an architecture for determining assessment results using similarity data in accordance with one or more embodiments described herein.

FIG. 7 illustrates an example, non-limiting, patient health questionnaire that can be automatically completed in accordance with one or more embodiments described herein.

FIG. 8 illustrates a flow diagram of an example, non-limiting, computer-implemented method that facilitates assessment response determination in accordance with one or more embodiments described herein.

FIG. 9 illustrates a flow diagram of an example, non-limiting computer-implemented method that facilitates assessment response determination in accordance with one or more embodiments described herein.

FIG. 10 illustrates a block diagram of an example, non-limiting, operating environment in which one or more embodiments described herein can be facilitated.

FIG. 11 depicts a cloud computing environment in accordance with one or more embodiments described herein.

FIG. 12 depicts abstraction model layers in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

The various aspects discussed herein relate to predictive analytics. Specifically, the various aspects can automatically determine on or more responses related to a diagnostic assessment. As discussed herein, an “assessment” can also be referred to as a questionnaire or query, depending on the context. For example, an “assessment” can be a judgment about a severity of a medical condition, which can be determined based on questions presented in the form of a questionnaire or query.

For example, the one or more responses can be derived from available data related to the issue(s) for which the assessment is directed. In some embodiments, the available data can be related to a target entity that is the subject of the assessment. In some embodiments, the available data can be related to other target entities that have experienced a same issue, a similar issue, and/or a related issue that prompted the diagnostic assessment.

In a specific, non-limiting, example, the various aspects discussed herein can automatically complete answers of a questionnaire, survey, assessment and so on. The questions can be related to the target entity. The answers can comprise automatically generated free text, selection of multiple choices among defined values, and/or selection of a single choice among defined values. The defined values can include, but are not limited to, categorical, numerical, Boolean, and/or text-sentences values.

As utilized herein an entity can be one or more computers, the Internet, one or more systems, one or more commercial enterprises, one or more computers, one or more computer programs, one or more machines, and/or machinery. Further, an entity can be one or more actors, one or more users, one or more customers, one or more humans, and so forth. An entity can be referred to as an entity or entities depending on the context. In a specific example, an entity can be medical patient. However, the disclosed aspects are not limited to this embodiment and an entity can be a vehicle or another device or machine being evaluated.

The answers can be generated using one or more of question and answer systems and/or similarity metrics, as will be discussed in further detail below. The question and answer systems can utilize one or more global domain knowledge sources and/or one or more specific knowledge sources. The similarity metrics can be utilized to discover profiles or other entities (e.g., other patients), which can be similar to a profile of the entity for which the assessment is being completed. The similarity metrics can be utilized to predict answers and/or to extend the precision, recall, and/or coverage of the generated answers.

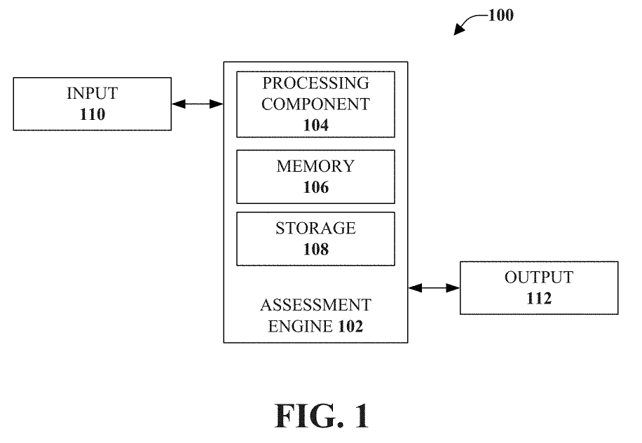

FIG. 1 illustrates a block diagram of an example, non-limiting, system 100 that facilitates intelligent automatic completion of information in response to one or more questions of an assessment in accordance with one or more embodiments described herein. Aspects of systems (e.g., the system 100 and the like), apparatuses, or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

In various embodiments, the system 100 can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise the system 100 can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

As illustrated, the system 100 can comprise an assessment engine 102, a processing component 104, a memory 106, and/or storage 108. In some embodiments, one or more of the assessment engine 102, the processing component 104, the memory 106, and/or the storage 108 can be communicatively and/or operatively coupled to one another to perform one or more functions of the system 100.

In one or more embodiments described herein, predictive analytics can be used to automatically complete one or more questions of an assessment. For example, the automatic completion can be based on information retained in a knowledge source database. The knowledge source database can comprise information related to one or more target entities. The information related to the one or more entities can be gathered over time and retained in the knowledge source database. According to a medical implementation, the information gathered can include medical histories, medical conditions, symptoms, responses to one or more questionnaires, medical diagnoses, details of treatment plans, and/or outcomes of the treatment plans. The information can be retained in the knowledge source database without identifying information of the patient, according to an implementation. Based on the retained information, when an identified patient is presented with a questionnaire, the system 100 can evaluate the knowledge source database (or multiple knowledge source databases) and map information known about identified patient to the information known about other patients. The predictive analytics can determine that, if conditions of the identified patient are similar to one or more other patients, the responses of the similar patients can be utilized to automatically complete one or more questions of a questionnaire for the identified patient.

The computer processing systems, computer-implemented methods, apparatus and/or computer program products employ hardware and/or software to solve problems that are highly technical in nature that are not abstract and that cannot be performed as a set of mental acts by a human For example, the one or more embodiments can perform the lengthy interpretation and analysis on the available information to determine which questionnaire from one or more questionnaires should be utilized for a target entity (e.g., the specific patient). In another example, the one or more embodiments can perform predictive analytics on a large amount of data to automatically complete a questionnaire with a high level of accuracy, even in the absence of detailed knowledge about the target entity.

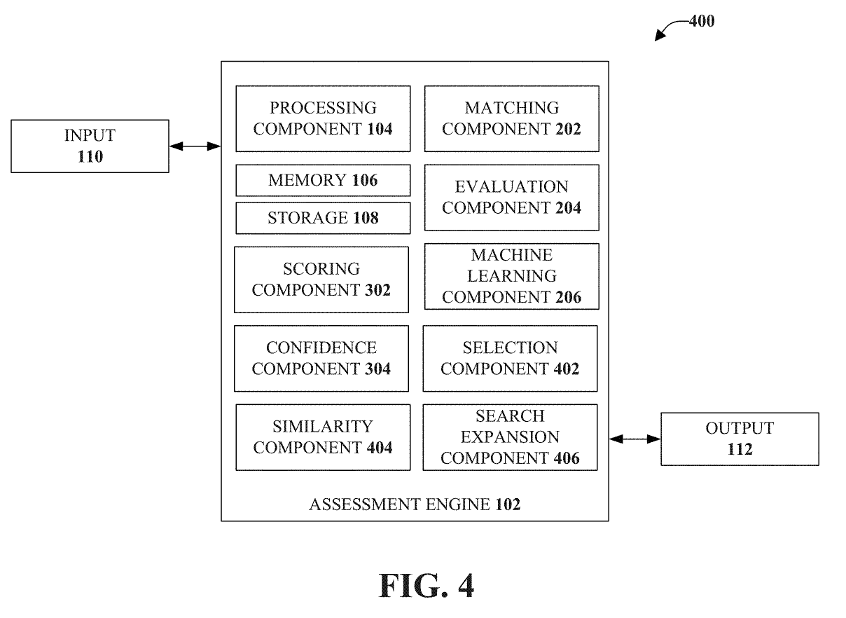

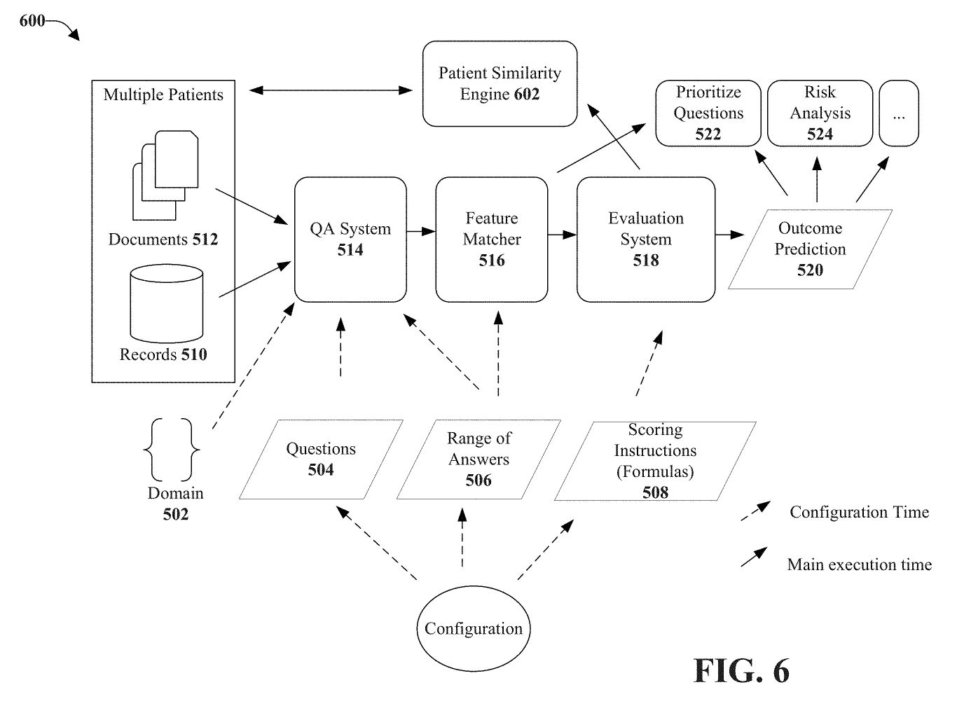

Further, even though the input data in the knowledge source database is scalable, there is no corresponding decrease in processing efficiency (e.g., an acceptable decrease in processing efficiency) due to the categorization of the information retained. For example, the machine learning predictive methods to calculate the patient similarity (e.g., a similarity component 404 of FIG. 4, a patient similarity engine 602 of FIG. 6) can scale linearly to the number of patients. The remainder of the machine learning predictive methods (e.g., the other components of FIG. 6) are not affected by the size of the input data (e.g., the number of patients, the amount of data per patient). In some implementations, there can be billions of input data, which cannot be transformed as a set of mental acts. For example, a human, or even thousands of humans, cannot efficiently, accurately, and effectively manually analyze the voluminous amounts of inputs and data that can be utilized to generate a response (e.g., an answer), which can be time consuming and might never be successfully performed. Thus, the one or more embodiments of the subject computer processing systems, methods, apparatuses, and/or computer program products can enable the automated determination of a suitable response to a questionnaire based on the input data. In an example, similarity metrics that can be utilized can be the Jaccard similarity or cosine similarity or more sophisticated learning algorithms (e.g., a Personalized Predictive Modeling and Risk Factor Identification using Patient Similarity).

Automatic completion of the one or more questions can increase a reliability of the assessment. Further, the automatic completion can create and/or maintain integrity of an electronic database, which can include the knowledge source database.

In various embodiments, the assessment engine 102 can receive input 110 (e.g., input data) that can be represented as sets of data (or, alternatively, data that is not provided as one or more sets, in some embodiments). In a medical example, the sets of data can include a patient history, which can include family history, medical conditions, notes, and/or voice recordings made by a physician after a physical exam. Other examples of data can include diagnosis, treatment plan including prescriptions prescribed, outcome of the treatment plan, medical tests (e.g., x-rays), and so on. In an example, at least a portion of the data can be initially captured in a physical format (e.g. the doctor can make handwritten notes), which can be electronically scanned as input 110. While the input 110 is described as received, in some embodiments, the received input 110 can be received in the distant past and stored in the system 100 and/or accessible over a network by the system 100. All such embodiments are envisaged.

In some embodiments, the sets of data can include historical information gathered over time. The historical information gathered over time can be medical records of one or more patients. As additional medical records are created for the patient, the information can be gathered and retained in a scalable format. For example, the additional medical records can include, but are not limited to, ongoing doctor visits, diagnosis, and treatment of other medical conditions.

According to an embodiment, the input data can include a record (or, in some embodiments, one or more records), which can include structured data and/or unstructured data. Structured data is data that has a degree of organization and the input of the data in a database can be seamless, allowing the data to be readily searchable using search operations and/or search engine algorithms (e.g., answers to a structured questionnaire, or a questionnaire answered in an electronic format (online)). Unstructured data is data that is not organized in a defined manner (e.g., lacks structure) and can include for example, text-heavy data (e.g., the doctor's handwritten notes). Compilation of the unstructured data into searchable data can be data-intensive.

The structured data can include complete information, incomplete information, and/or partial information. The complete information can include a complete medical history and/or a fully answered questionnaire. The incomplete information can include a medical history that is missing information (e.g., family medical history, medications currently being taken). The partial information can include maternal family medical history, but not paternal family medial history.

In another embodiment, the input data can include profiles associated with one or more entities related to previous assessments and/or questionnaires. According to another embodiment, the input data can include semi-structured knowledge, such as, but not limited to, semantic graphs and/or domain knowledge. A semantic graph is a directed or undirected graph that comprises vertices that represent concepts and edges that represent semantic relations between the concepts. The domain knowledge comprises, for example, information known about medical conditions and treatment thereof. Such information can be based on medical textbooks and journal articles. Another type of data can include patient-centric data, which is data known about an identified patient.

In other embodiments, the input data can include assessments and/or questionnaires that can comprise one or more questions and possible answers (e.g., multiple choice, yes/no, and so on). In an additional or alternative embodiment, the input data can include scoring instructions for the questionnaires (e.g., a defined manner of scoring the questionnaire using a scoring formula).

The assessment engine 102, upon or after receiving or accessing the input 110 that includes one or more questionnaires, can evaluate the one or more questionnaires and determine a response (or multiple responses) to the questionnaire. For example, as it relates to a target entity, respective questionnaires can be compared, by the assessment engine 102, to information known about the target entity. For example, the assessment engine 102 can assess the medical history of the target entity and evaluate the medical history to determine responses to one or more questions in the questionnaires. The determination can be based on historical responses to similar questions, based on a medical history already provided, and/or based on a treatment plan being followed by the target entity.

In some embodiments, if information related to the target entity is not available, information related to one or more other entities can be utilized to determine the response. For example, patient-centric data for other patients can be utilized to evaluate the responses of other patients to determine if that response would apply to the target entity. For example, if another patient has a similar medical history and similar symptoms as the target entity, the information from the other patient can be utilized to determine the response for the target entity.

In another example, an average response of one or more entities can be utilized for the target entity in order to answer the questionnaire. For example, a questionnaire includes two related questions and the answer to one of the questions can be determined with a high level of confidence based on the information known about the target entity. However, the second question is not known due to the absence of data related to the target entity. In this situation, the assessment engine 102 can evaluate other data, which can be domain knowledge data and/or patient-centric data (e.g., from other patients). According to an example, based on this evaluation, the assessment engine 102 can determine that, based on the other data, 99% of the time if the first answer is “yes,” the second answer is “no.” Thus, it can be inferred with 99% confidence that if the first answer for the target entity is “yes,” then the second answer is “no.”

The one or more responses can comprise output data that can be provided as output 112 from the assessment engine 102. In an embodiment, the output 112 can comprise answers to a questionnaire and/or an assessment. Additionally, the output 112 can include a confidence value associated the responses. In some embodiments, the output 112 can include scoring data. For example, if scoring instructions are provided to the assessment engine 102, the assessments can be scored and ranked based on the determined responses and the associated confidence values.

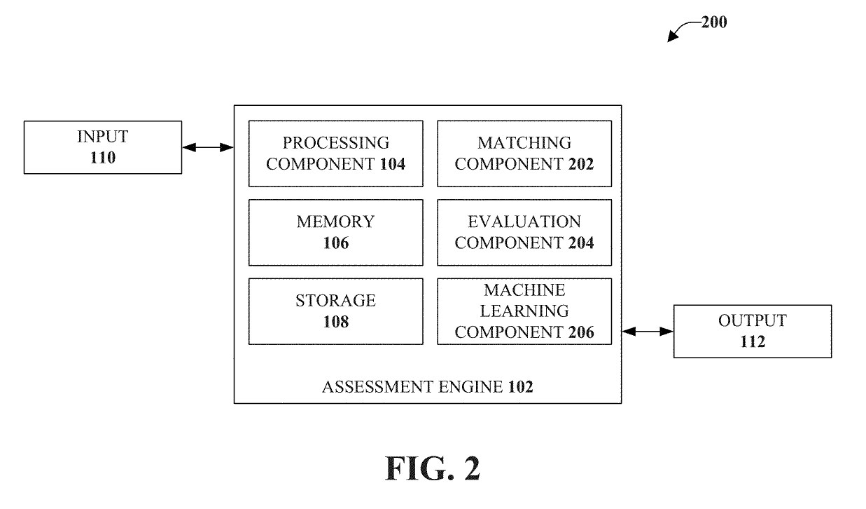

FIG. 2 illustrates a block diagram of an example, non-limiting, system 200 that facilitates automatic completion of one or more questionnaires based on predictive analysis in accordance with one or more embodiments described herein. Repetitive description of like elements employed in other embodiments described herein is omitted for sake of brevity.

The system 200 can comprise one or more of the components and/or functionality of the system 100, and vice versa. As illustrated, the assessment engine 102 can include a matching component 202, an evaluation component 204, and a machine learning component 206. The matching component 202 can compare input data from a knowledge source database to at least one question in a query. The input data can be associated with a target entity. For example, the knowledge source database can comprise an electronic text corpus associated with the target entity.

According to some embodiments, the knowledge source database can comprise a global domain knowledge database and a specific knowledge database. The global domain knowledge database can comprise structured electronic information and unstructured electronic information. The global domain knowledge can include data known across an industry that can be considered standard practice (e.g., if a first medication is prescribed, the patient should also be prescribed a second medication). The specific knowledge database can comprise an electronic profile for the target entity. In an example, the specific knowledge database can include patient centric-knowledge. The patient centric-knowledge can include, for example, information that is unique for the patient and can include historical medical conditions and current medical conditions.

The query can be an assessment and/or questionnaire selected for the target entity and intended to evaluate one or more conditions and/or factors related to the target entity. For example, the target entity can be a vehicle (or other machinery) that is experiencing a failure or potential failure. The assessment can include specific questions related to the failure to diagnose and/or repair the vehicle. For example, the assessment can be related to various components or conditions (e.g., noises, vibrations, and so on) that can contribute to a diagnosis of the vehicle failure. In this example, the knowledge source database can comprise an electrical schematic, a parts list, an operating manual, and/or a maintenance manual for the vehicle.

The following is an example related to a medical patient (e.g., the target entity) that is experiencing symptoms of a medical condition. In this example, the assessment can include specific questions related to a diagnosis of the medical condition and/or continuing treatment of a medical condition (e.g., arthritis, diabetes, depression, sleep disorders, neuropathy, and so on). Further to this example, the knowledge source database can comprise a medical record of the patient.

The evaluation component 204 can determine an applicability of the input data to the at least one question based on a feature value. The feature value can comprise a defined response format (e.g., a yes/no answer, a true/false answer, a numerical ranking (e.g., on a scale from 0 to 3), a text response, and so on). Thus, the evaluation component 204 can compare the defined response format to the input data to determine if the input data is in the same or similar format as the defined response. If the formats match, the evaluation component 204 can use the input data for the response. However, if the formats do not match, the evaluation component 204 can implement one or more changes to format of the input data for the response. The format changes can be based on a conversion of the format of the input data to the format of the defined response. For example, continuing the medical example, the input data evaluated by the matching component 202 can include a previous question (e.g., medical history, family medical history) answered by the patient and, in this case, the evaluation component 204 can determine the input data is directly applicable to the patient. However, if the input data answer is in the format of “false” for the question “do you have severe headaches,” the second response can be in the format of “no” for the same or similar question. In another example, if the first response is in the format of “7” on a scale from 0 to 10 (with “0” being not at all and “10” being nearly every day), the second response can be in the format of “yes.”

In another example, a patient may be experiencing a new condition, not previously experienced (e.g., tingling in the arms). In this case, the matching component 202 can return input data that is related to the current condition of the patient (e.g., tingling in the arms). The determination of the condition (e.g., tingling in the arms) can be based on a reason for a doctor's visit, which can be ascertained when the appointment is made. In another example, the determination of the condition can be based on medications the patient is taking and knowledge about side affects of the medications. Accordingly, input data related to the other patients can be utilized to respond to the assessment. In another example, if the patient is being treated for a sleep disorder, it can be determined that semantically related questions (e.g., trouble falling asleep, waking at night, sleepiness, insomnia, trouble staying asleep, and so on) should be returned by the matching component 202.

Based on the information known about the target entity, the evaluation component 204 can determine that the results for the other patients and/or the semantically related questions are applicable. Therefore, responses based on the related data can be utilized for the current assessment. For example, the evaluation component 204 can evaluate the input data for key words, phrases, medications, and/or diagnoses of the target entity to find a match with the other patients. Based on this match, the evaluation component 204 can determine how the other patients responded to a similar assessment and use those responses for the target entity. In some cases, the evaluation component 204 can determine the results are not related (e.g., a question/answer related to pregnancy when the patient is not capable of having offspring). Therefore, the evaluation component 204 can respond to the question appropriately based on the data known about the target entity.

The machine learning component 206 can generate a response to the at least one question. The response generated by the machine learning component 206 can be based on the applicability of the input data to the target entity and in conformance to the feature value, which defines a format of the response. For example, the input data can comprise a first format and the defined format of the response can comprise a second format. The machine learning component 206 can evaluate historical data to determine how, historically, the first format has been transformed into the second format. Based on this knowledge, the machine learning component 206 can perform the same or a similar transformation in order to provide the response to the at least one question. In another example, if a historical transformation is not found, the machine learning component 206 can perform a predictive analysis to predict that a first format of a first type (e.g., yes/no) can be transformed to a second format of a second type (e.g. scale from 0 to 3). According to some implementations, to generate the second response the machine learning component 206 can transform a previous response comprising a third feature value (e.g., a scale that utilized smiling faces and frowning faces to indicate a level of discomfort) to a format comprising the second feature value. This predicative analysis can be based on historical data that indicates an entity responded to similar questions in two questionnaires having two format types. For example, a first question in a first questionnaire was answered in the first format with a “yes” response and a second question in a second questionnaire was answered in the second format with a “3” response. Based on this analysis, the machine learning component 206 can predict the response in the defined format and perform the transformation to automatically provide the response.

In some embodiments, if the input data is related to a first format of the response, the machine learning component 206 can change the format to a second format in order to conform to the format of the response employed for the current assessment. For example, if the first response is in the format of “true” for the question “are you feeling sad,” the second response can be in the format of “yes” for the same or similar question. In another example, if the first response is in the format of “0” on a scale from 0 to 3 (with “0” being not at all and “3” being nearly every day), the second response can be in the format of “no.”

According to some embodiments, more than one question can be included in the query. Thus, the matching component 202 can compare the input data retained in the knowledge source database to at least a second question included in the received query. The evaluation component 204 can determine an applicability of the input data to the at least one question based on a feature value associated with at least the second question. For example, the one or more inquiries or questions can have a same feature value (e.g., all are yes/no answers), or two or more inquires can have different features values (e.g., answers to questions 1-5 should be in a yes/no format and answers to questions 6-11 should be in a numerical ranking format).

The machine learning component 206 can generate a first response to the first inquiry in conformance with a first feature value, as discussed above. Further, the machine learning component 206 can generate a second response to the second inquiry in conformance with a second feature value. The machine learning component 206 can generate subsequent responses to subsequent inquiries in conformance with subsequent feature values. For example, a questionnaire might have different questions with different response formats, such as questions 1-10 have a yes/no format and questions 11-20 have a scale format. Thus, the machine learning component 206 can generate responses in the yes/no format for questions 1-10 and can generate responses in the scale format for questions 11-20. The changes in the response format can be facilitated by the machine learning component 206 based on a transformation applied to a previous response from the target entity (which might be in a different feature value format) and/or previous responses from other entities, as discussed above.

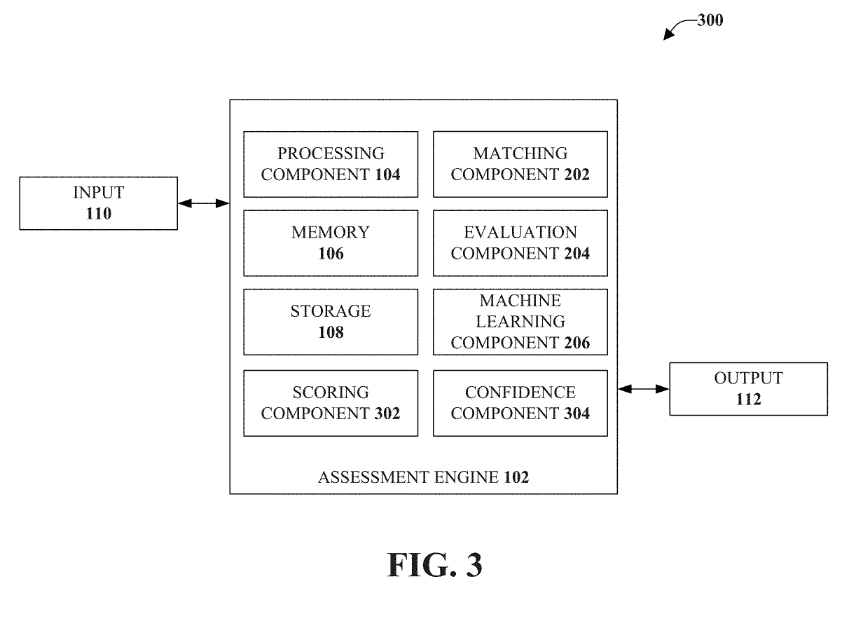

FIG. 3 illustrates a block diagram of an example, non-limiting, system 300 that facilitates an interpretable recommendation for customized outputs in accordance with one or more embodiments described herein. Repetitive description of like elements employed in other embodiments described herein is omitted for sake of brevity.

The system 300 can comprise one or more of the components and/or functionality of the system 100 and/or the system 200, and vice versa. As discussed, the machine learning component 206 can generate one or more responses to the one or more questions. According to an embodiment, the machine learning component 206 can formulate the response based on the feature value that includes a restriction defined for a format of the response. For example, the restriction can be that the response should be in a yes/no format, should be in a scale format (e.g., a scale from 1 to 5), and/or should be in the format of a range between a smiling face (e.g. no pain) and a frowning face with tears (e.g., extreme pain). Another restriction can be that the response should include a checkmark or an “x” indicating a positive response. The restriction can be selected from a group consisting of a Boolean response, a text response, a numerical response, and/or a categorical response.

As illustrated, the system 300 can include a scoring component 302 and a confidence component 304. The scoring component 302 can provide a ranked score of the responses based on instructions associated with the query. A scoring instruction used to generate the ranked score can be unique for a questionnaire. For example, a questionnaire can include 50 questions. The scoring instruction can indicate that for the odd numbered questions between 1 and 49 with a “yes” response, a score value of +5 should be assigned and for those with a “no” response, a score value of “0” should be assigned. Further, for the even numbered questions between 2 and 48, a score of “−2” should be assigned if the response is “yes” and a score value of “+4” should be assigned if the response is “no.” For question 50, a “yes” response is assigned a score value of “1” and a “no” response is assigned a score value of “7.” The numerical values of the responses can be added together to obtain a final score. Further, if the final score is within a first range of values, it indicates a first severity level of the medical condition and a first treatment plan can be followed. If the final score is within a second range of values, it indicates a second severity level of the medical condition and a second treatment plan can be followed. Further, if the final score is within a third range of values, it indicates a third severity level of the medical condition and a third treatment plan can be followed. In some embodiments, the ranked score can be optional (e.g., there are no scoring instructions and, therefore, the query does not add up the values to derive a condition severity as discussed above). However, if instructions are provided with the query, the scoring component 302 can rank the respective responses based on one or more scoring instructions defined for the query (e.g., the first severity level, the second severity level, and the third severity level described above). For example, the scoring component 302 can generate a score value based on the first response and the second response, and based on a score formula defined for the received questionnaire. It is noted that the scoring instructions, if provided, can be tailored for the questionnaire. Further, the scoring instructions can take many different formats.

In a simple, non-limiting, example, the scoring instructions can indicate to apply one point value to all “no” answers and three point values to all “yes” answers, and add the scores together to obtain the ranked score. The ranked score is then compared to a list that indicates: a score between a first score and a second score is a mild condition; a score between the second score and a third score is a moderate condition; and a score above the third score is a severe condition.

As noted, the computation by the scoring component 302 can be optional, depending on the query being completed. For example, a query that has a minimal number of questions (e.g., three questions) does not comprise a score formula. However, for another query that has a greater quantity of questions, or where different questions relate to different conditions, one or more scoring instructions could be provided.

The confidence component 304 can assign a confidence score to the responses. In an embodiment, the confidence score can be based on the applicability of the response to the target entity. The applicability of the response to the target entity can relate to how closely the response is determined to be tailored for the target entity. This determination can be made without receiving an input from the target entity and/or can be based on information about other entities. If the response is applicable to the target entity with a high degree of confidence, it indicates the target entity would have provided the same response. If the applicability of the response to the target entity is uncertain (e.g., a guess is made), a low degree of confidence can be assigned to the response. In accordance with some implementations, if a set of answers are obtained for the query, the answer(s) with the highest confidence can be selected. It is noted that the answer(s) with the highest confidence level might have a low confidence level (e.g., under 50%).

Thus, if the question was answered based on a previous response received from the target entity, a confidence score indicating a high level of confidence can be assigned to the response by the confidence component 304. However, if the question was answered based on an average response across similarly situated entities, a lower level of confidence can be assigned to the response by the confidence component 304.

Respective confidence scores can be assigned to the different responses by the confidence component 304. Thus, a first response can have a first confidence score, a second response can have a second confidence score, and so on. The confidence scores can be utilized to probe further and/or can indicate another assessment or questionnaire should be utilized for the target entity.

FIG. 4 illustrates a block diagram of an example, non-limiting, system 400 that facilitates an interpretable recommendation for customized outputs in accordance with one or more embodiments described herein. Repetitive description of like elements employed in other embodiments described herein is omitted for sake of brevity.

The system 400 can comprise one or more of the components and/or functionality of the system 100, the system 200, and/or the system 300, and vice versa. The system 400 can include a selection component 402, the similarity component 404, and a search expansion component 406. In some embodiments, more than one questionnaire can be utilized to diagnose a condition as discussed herein. In these cases, it can be beneficial to select a single questionnaire that is focus based on the condition and information known about the target entity.

Accordingly, the selection component 402 can evaluate a relevancy of an assessment for the target entity based on the response to the inquiry. For example, based on two or more questionnaires, a preliminary assessment can be automatically performed on the questionnaires to determine whether one or more of the questionnaires is better suited for the target entity (e.g., based on confidence score levels). Based on the evaluation, the selection component 402 can facilitate a selection of the assessment from one or more alternative assessments based on a determination that the relevancy satisfies a defined condition. The assessment can be the received questionnaire. The defined condition can be that the questions are relevant to a current condition of the target entity. Another defined condition can be that a confidence level assigned to a set of questions of the selected questionnaire has a higher confidence level than another confidence level assigned to another set of questions of another questionnaire.

The similarity component 404 can determine that input data related to the target entity is not included in the knowledge source database and/or is not relevant to a selected questionnaire. For example, the similarity component 404 can determine that information related to the target entity is not included in the input data based on a search of the data corresponding to the target entity. Accordingly, there can be an absence of input data for the target entity, at least as it pertains to the current questionnaire.

Thus, the similarity component 404 can evaluate at least a second response from at least a second target entity. The first target entity and the second target entity can be determined to be related based on a first profile of the first target entity and a second profile of the second target entity. For example, the first profile and the second profile can be determined to have a feature having a defined level of similarity.

To evaluate the knowledge source database for the comparisons, the similarity component 404 can utilize domain knowledge and patient-centric knowledge contained in the knowledge source database. For example, a patient could have headaches and based on similarities between the patient and other similarly situated patients, the similarity component 404 can utilize the patient-centric knowledge about those other patient. Based on this information, the similarity component 404 can determine that the patient (e.g., the target entity) most likely also experiences insomnia.

In another example, the similarity component 404 can utilize statistics in order to automatically complete one or more questions. For example, an assessment can have two questions and only the answer to the first question is known with a high level of confidence. However, based on historical information related to other entities, the similarity component 404 determines that in 99% of the cases, when the first question is “yes,” for example, the answer to the second question is “no.” Thus, the similarity component 404 can determine the answer to the second question with a high level of confidence (e.g., 99% confidence if the answer to the first question was “yes”).

The search expansion component 406 can semantically expand one or more concepts related to the target entity and/or the questionnaire. For example, the search expansion component 406 can semantically expand concepts such as “staying asleep” and “sleeping” to find evidence linked to the patient's profile. Accordingly, the related concepts and associated responses can be utilized to perform the automatic completion of the questionnaire as discussed herein. The semantic expansion can be determined based on dictionary definitions, synonyms, and/or terms of art. In a specific example, the semantic expansion can correspond to words used in medical professional terminology to words used by a patient. For example, a doctor may describe a condition as “edema” while a patient describes the condition as “swelling.” Accordingly, if a question asks about swelling in the joints, the doctor's notes related to edema can be utilized to answer the question. In another example, if on a previous medical exam the doctor provided notes that the patient had pulmonary edema, the search expansion component 406 can use this diagnose to respond to a question related to previous lung problems, lung disease, and/or heart disease.

According to some embodiments, the machine learning component 206 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the machine learning component 206 can employ principles of probabilistic and decision theoretic inference to determine one or more responses based on information retained in a knowledge source database, as well as patient-centric data. Additionally or alternatively, the machine learning component 206 can rely on predictive models constructed using machine learning and/or automated learning procedures. Logic-centric inference can also be employed separately or in conjunction with probabilistic methods. For example, decision tree learning can be utilized to map observations about data retained in a knowledge source database to derive a conclusion as to a response to a question.

The machine learning component 206 can infer one or more responses to one or more questions in an assessment and/or selection of an assessment from two or more assessments by obtaining knowledge about various information. The information for which knowledge can be obtained can include, but is not limited to, the purpose of the assessment, one or more target entities being assessed, historical information retained in one or more databases, and/or interaction with one or more external computing devices to evaluate the assessments and/or questions presented therein. According to a specific embodiment, the system 200 can be implemented for automatic completion (e.g., autofilling) of one or more assessments provided in an electronic format through one or more computing devices.

Based on the knowledge, the machine learning component 206 can make an inference based on whether an assessment from two or more available assessments should be selected based on information known about a target entity for which the assessment is intended. Further, based on the knowledge, the machine learning component 206 can automatically determine one or more responses to questions presented during the assessment. Further, the machine learning component 206 can assign respective confidence levels or respective confidence scores to the one or more responses. In addition, the machine learning component 206 can optionally determine a result to a scoring instruction based on the one or more responses and an instruction set related to the scoring instruction. In accordance with some implementations, a Perason correlation between the feature values in the first format and the second format can be calculated.

As used herein, the term “inference” refers generally to the process of reasoning about or inferring states of the system, a component, a module, the environment, and/or assessments from one or more observations captured through events, reports, data, and/or through other forms of communication. Inference can be employed to identify a specific context or action, or can generate a probability distribution over states, for example. The inference can be probabilistic. For example, computation of a probability distribution over states of interest can be based on a consideration of data and/or events. The inference can also refer to techniques employed for composing higher-level events from one or more events and/or data. Such inference can result in the construction of new events and/or actions from one or more observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects.

The various aspects (e.g., in connection with automatic completion of one or more assessments associated with a target entity through the utilization of various structured and/or unstructured electronic data) can employ various artificial intelligence-based schemes for carrying out various aspects thereof. For example, a process for evaluating one or more parameters of a target entity can be utilized to predict one or more responses to the assessment, without interaction from the target entity, which can be enabled through an automatic classifier system and process.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to prognose or infer an action that should be employed to make a determination. The determination can include, but is not limited to whether to select a first assessment instead of a second assessment from an assessment database and/or whether a question presented in the selected assessment is similar to another question in an assessment previously completed. Another example includes whether, in the absence of specific information about the target entity, data from another target entity or a group of target entities can be utilized (which can impact a confidence score). In the case of automatic completion of assessments, for example, attributes can be identification of a target entity based on historical information and the classes can be related answers, related conditions, and/or related diagnoses.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing and recording target entity behavior, by receiving extrinsic information, and so on). For example, SVM's can be configured through a learning phase or a training phase within a classifier constructor and feature selection module. Thus, a classifier(s) can be used to automatically learn and perform a number of functions, including but not limited to, determining according to a defined criteria a relevant assessment based on a given set of characteristics of a target entity. Further to this example, the relevant assessment can be selected from a multitude of assessments. Another function can include determining one or more responses to the assessment in view of information known about the target entity and assigning confidence scores to the responses. The criteria can include, but is not limited to, historical information, similar entities, similar subject matter, and so forth.

Additionally or alternatively, an embodiment scheme (e.g., a rule, a policy, and so on) can be applied to control and/or regulate an embodiment of automatic selection and/or completion of assessments before, during, and/or after a computerized assessment process. In some embodiments, based on a defined criterion, the rules-based embodiment can automatically and/or dynamically interpret how to respond to a particular question and/or one or more questions. In response thereto, the rule-based embodiment can automatically interpret and carry out functions associated with formatting the response or one or more responses based on an electronic format for receipt of the responses by employing a defined and/or programmed rule(s) based on any desired criteria.

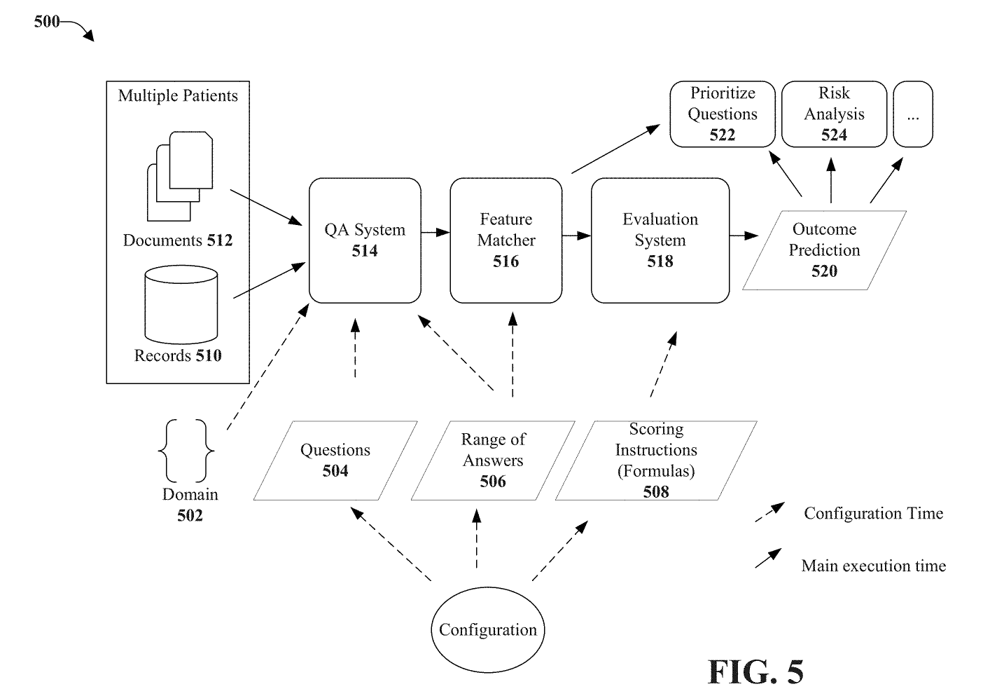

FIG. 5 illustrates a block diagram of an example, non-limiting, flow diagram 500 of an architecture that facilitates determination of assessment results in accordance with one or more embodiments described herein. Repetitive description of like elements employed in other embodiments described herein is omitted for sake of brevity.

The following provides an example of a specific embodiment related to a medical questionnaire. However, the disclosed aspects are not limited to this embodiment. Instead, the aspects can be applied to various applications that utilize an assessment to diagnose and/or make various determinations. For example, an assessment can be performed to diagnose one or more conditions of a vehicle. In another example, an assessment can be performed to improve or streamline a manufacturing process.

For a medical embodiment, given a patient profile, a corpus, and a questionnaire, the various aspects can answer the questions in the questionnaire (if the answers are known), or can predict the answers using the corpus. The patient profile can include structured and/or unstructured data. Further, the corpus can include structured and/or unstructured data. According to some embodiments, the corpus can include patient profiles, clinical notes, knowledge databases, vocabularies, and a questionnaire. Additionally, a confidence score and/or uncertainty score can be provided for the answers.

As discussed herein, if an answer cannot be found using the patient information and domain knowledge, machine learning techniques can be utilized. The machine learning techniques can predict answers based on other patients that have patient profiles having a defined level of similarity (e.g., recommended answers, suggested answers, and so on) with a target patient.

According to various embodiments, an assessment can comprise one or more questions that can include one or more pre-defined answers (feature values) and scoring instructions based on the answers. For the one or more questions, the answers determined by the system using the corpus can be matched to the feature values for the questions with a certain confidence. After execution of the one or more questions, the assessment can be assigned a score based on the scoring instructions with a certain confidence value.

Data input can include a patient profile, which can include structured and unstructured data. For example, the structured data can be a system of records, which can be incomplete and/or can contain partial information. The unstructured data can include a collection of case notes. In an example, non-limiting, embodiment, the data input can include x-rays, ultrasounds, or other medical exams, and interpretations thereof. In another non-limiting example, the data input can include voice recordings captured during previous medical exams, notes input by a nurse and/or doctor, and so on.

Data input can also include profiles associated with other patients. Further, data input can include semi-structured knowledge, such as semantic graphs and/or domain knowledge (e.g., Clinical Assessment Protocols (CAPs), such as InterRAl or RAPS). Data input can also include assessments, which can be in the form of questionnaires comprising one or more questions and possible actions. Further, data input can optionally include scoring instructions for the assessments.

Output can include answers for the questionnaires with a confidence value. The answer can be positive, negative, uncertain, or from a pre-defined feature value as given by the assessments. In the embodiments where scoring instructions are provided, the assessments can be scored and ranked based on the predicted answers and confidence values.

With continuing reference to FIG. 5, during a configuration phase, domain knowledge 502 can be established. It is noted that the dashed line arrows indicate configuration time and the solid line arrows indicate main execution time. The domain knowledge 502 can include ontologies describing diseases, synonyms, and other information. Also during the configuration phase, questions 504, and expected range of answers 506, and scoring instructions 508 can be established.

During a usage phase, the system takes as additional input, one or more records 510. The one or more records 510 can include information about a patient from a system of records. Further, related documents 512 can also be provided as additional input. The related documents can include case notes, for example.

A question and answer system 514 (QA system) can match the questions to the data from the one or more records 510 and/or the related documents 512. The question and answer system 514 can also match the questions to the domain knowledge 502. The question and answer system 514 can take into consideration any restrictions with respect to the range of answers. For example, a question can expect a Boolean answer.

The answers to the questions can be matched by a feature matcher 516 to one or more features. For example, the answers can be mapped to a multi-choice set of pre-defined answers. The questions and corresponding values for the features can be evaluated by an evaluation system 518. The evaluation system can perform the evaluation based on the scoring forming provided, for example. Thus, an outcome 520 can be determined. The outcome 520 can be used, for example, to prioritize 522 the questions that a case worker is prompted to ask (in conjunction with the feature values). In addition, the outcome 520 can be utilized for risk analysis 524.

FIG. 6 illustrates a block diagram of an example, non-limiting, flow diagram 600 of an architecture for determining assessment results using similarity data in accordance with one or more embodiments described herein. Repetitive description of like elements employed in other embodiments described herein is omitted for sake of brevity.

In some situations, not enough values are available to answer a question for a patient. Accordingly, the patient similarity engine 602 can be utilized to retrieve records for similar patients. For example, the similar patients can be patients that have similar symptoms, similar diseases, similar family history, and so on. If there is enough evidence extracted from the similar patient's records, these records can be utilized to determine the answer to the question. In this manner, the system can compensate for sparse data and can make determinations based on similar situations.

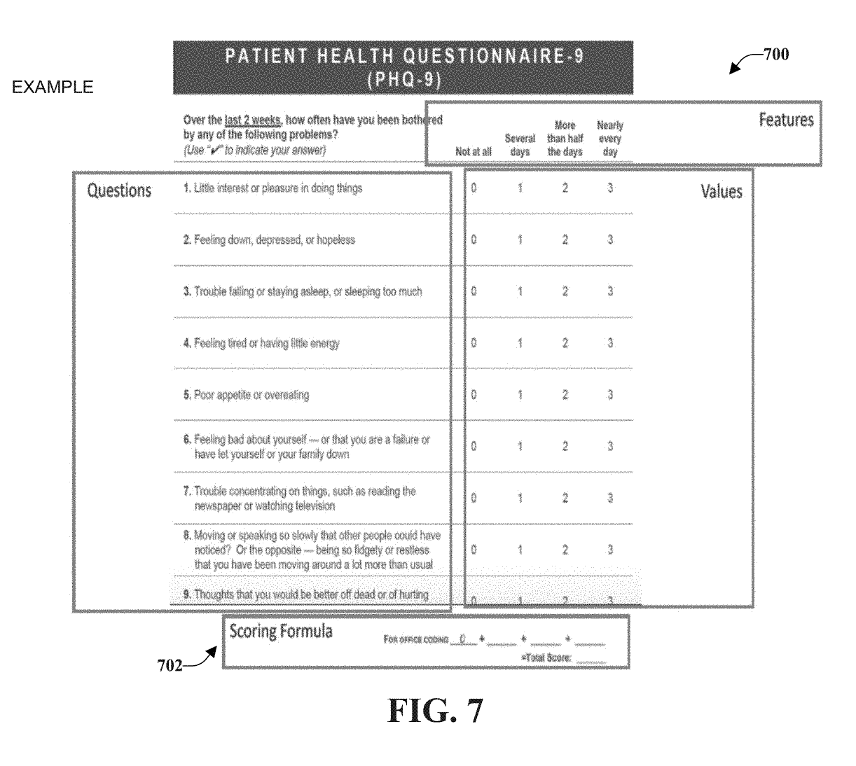

FIG. 7 illustrates an example, non-limiting, patient health questionnaire 700 that can be automatically completed in accordance with one or more embodiments described herein. Repetitive description of like elements employed in other embodiments described herein is omitted for sake of brevity. As illustrated, various questions are provided. To answer the questions, a value from “0” to “3” can be selected. A scoring instruction, which can be in the format of a scoring formula 702 can also be provided.

In a use case example, care programs can include several assessments. The assessments can comprise, for example, (1) multiple questions and answers; (2) a scoring function based on the choice of the answers; and (3) guidelines and/or best practices based on the resultant score. When a patient is enrolled into a program, care workers should prioritize which assessments and questions to run in order to identify user needs and risks. For example, the patient health questionnaire 700, which can be a depression assessment, includes questions such as: “Trouble falling asleep” and “Poor appetite.”

The various aspects discussed herein attempt to answer the questions using the available domain and patient-based knowledge. In order to perform the automatic answering, concepts such as “staying asleep” and “sleeping” can be semantically expanded to find evidence linked to the patient's profile. For example, the concepts can be expanded to insomnia, falling asleep, and/or sleep disorders. Machine learning can be utilized to determine the importance of the factors found in the evidence and correlations to the question concepts. For example, brand names of sleeping medications can be associated with “insomnia,” “obesity,” and “weight gain,” which can also associated with “overeating.”

Upon or after the question is semantically expanded, answers and evidences can be retrieved based on question and answer methods over structured and/or unstructured data. If there is not enough evidence or answers for the patient found, a combination of machine learning algorithms can be used to predict the answers to the questions based on similar patients. The similar patients can be patients with similar profiles and conditions to the given patient, who often have sleeping problems.

Based on the evidence found, a confidence score can be assigned to the answer. The higher the confidence score, the more likely the answer is accurate. However, the disclosed aspects are not limited to this embodiment and other types of rankings can be utilized (e.g., a lower score indicates an accurate answer, an alphabetical ranking, a star-ranking system, and so on).

Answers can be mapped to positive/negative/uncertain and/or one or more defined feature values as provided by the questions in the assessment. If a scoring function is provided for the question and answer pairs in the assessment, the assessment score can be calculated based on the predicted answers for the patient, the confidence score, and the scoring function.

In some embodiments, the assessments can be prioritized based on their score. Assessments (and/or questions) with higher scores can indicate to a care worker that the assessment should be executed. According to some implementations, assessments with higher scores can indicate that questions related to the patient should be automatically determined for that particular assessment.

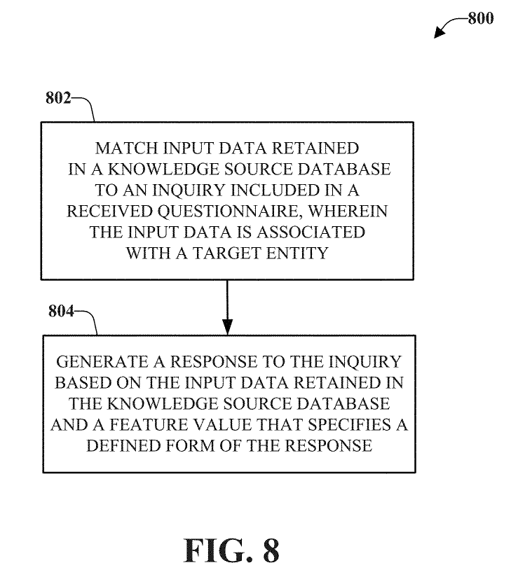

FIG. 8 illustrates a flow diagram of an example, non-limiting, computer-implemented method 800 that facilitates assessment response determination in accordance with one or more embodiments described herein. Repetitive description of like elements employed in other embodiments described herein is omitted for sake of brevity.

At 802 of computer-implemented method 800, input data retained in a knowledge source database can be matched to an inquiry included in a received questionnaire, wherein the input data is associated with a target entity (e.g., via the matching component 202). For example, the questionnaire can be received in response to a request for questionnaires related to a specific issue in order to derive an associated diagnosis (e.g., a medical issue or symptom, a machinery malfunction). The knowledge source database can include information about the target entity such as information already provided by (or determined about) the target entity. In another example, the knowledge source database can include information about other target entities and/or information related to the specific issue.

At 804 of the computer-implemented method 800, a response to the inquiry can be generated based on the input data retained in the knowledge source database and a feature value that specifies a defined form of the response (e.g., via the machine learning component 206). For example, the response can be based on an applicability of the input data to the target entity. Further, generating the response can be based on machine learning applied to information retained in the knowledge source database.

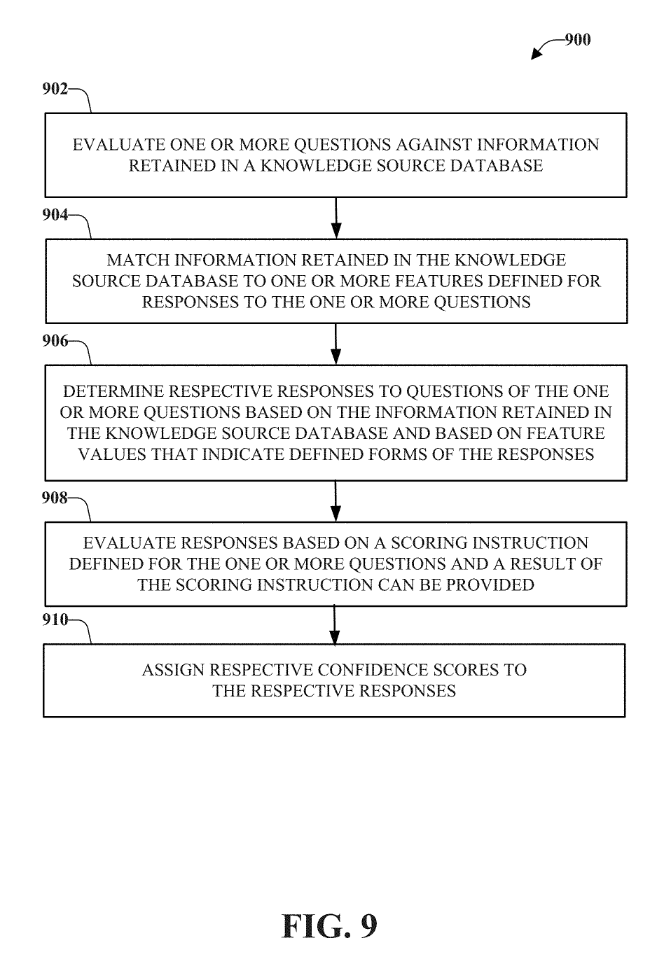

FIG. 9 illustrates a flow diagram of an example, non-limiting computer-implemented method 900 that facilitates assessment response determination in accordance with one or more embodiments described herein. Repetitive description of like elements employed in other embodiments described herein is omitted for sake of brevity.

At 902 of the computer-implemented method 900, one or more questions can be evaluated against information retained in a knowledge source database (e.g., via the matching component 202). The knowledge source database can comprise data related to a target entity. In addition, the knowledge source database can comprise data related to other target entities. Further, the knowledge source database can comprise data related to one or more assessments or questionnaires.

The information retained in the knowledge source database can be matched, at 904, to one or more features defined for responses to the one or more questions (e.g., via the evaluation component 204). For example, the knowledge source database can include global domain knowledge and/or patient-centric knowledge. The global domain knowledge can include medical information from medical textbook, treatises, journals, or other sources of medical knowledge. The patient-centric knowledge can be information related to an individual patient. Further, the patient-centric knowledge can be respective information corresponding to one or more patients.

At 906 of the computer-implemented method 900, respective responses to questions of the one or more questions can be determined based on the information retained in the knowledge source database and based on feature values that indicate defined forms of the responses (e.g., via the machine learning component 206). Accordingly, the determination can be based on a machine learning applied to the information retained in the knowledge source database.

At 908 of the computer-implemented method 900, responses can be evaluated based on a scoring instruction defined for the one or more questions and a result of the scoring instruction can be provided (e.g., via the scoring component 302). The scoring instruction can be defined for the one or more questions.

According to some embodiments, at 910 of the computer-implemented method 900, respective confidence scores can be assigned to the respective responses (e.g., via the confidence component 304). The respective confidence scores can provide an indication of a relevancy of the respective responses to the target entity. In some embodiments, different responses can have different confidence levels. According to some embodiments, a confidence score averaged for all responses to the one or more questions can be provided.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

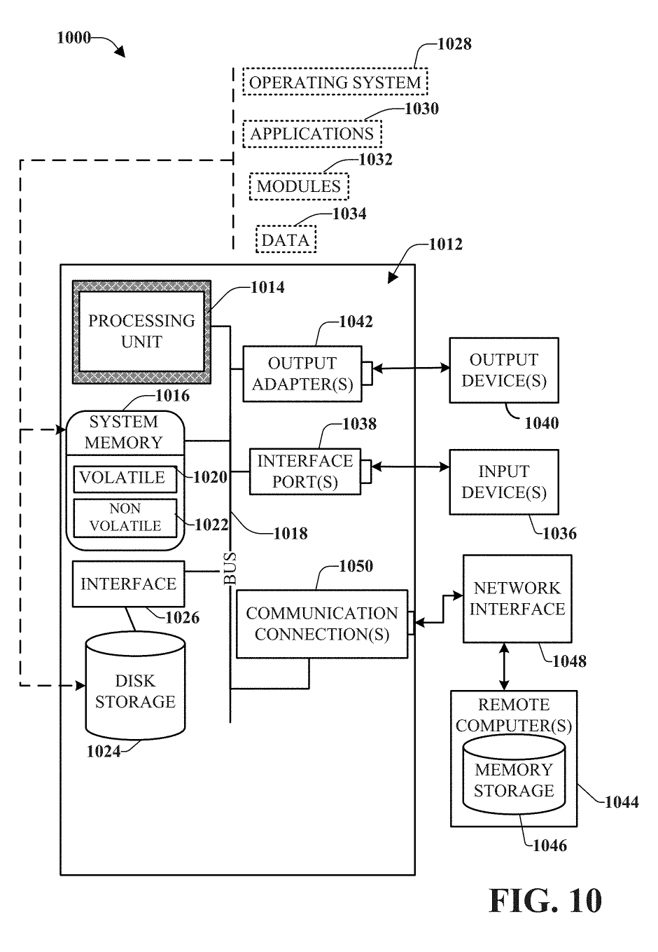

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity. With reference to FIG. 10, a suitable operating environment 1000 for implementing various aspects of this disclosure can also include a computer 1012. The computer 1012 can also include a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI). The system memory 1016 can also include volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1020 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1024 to the system bus 1018, a removable or non-removable interface is typically used, such as interface 1026. FIG. 10 also depicts software that acts as an intermediary between users and the basic computer resources described in the suitable operating environment 1000. Such software can also include, for example, an operating system 1028. Operating system 1028, which can be stored on disk storage 1024, acts to control and allocate resources of the computer 1012. System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a method of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. The characteristics are as follows: on-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a high level of abstraction (e.g., country, state, or data center). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of selected networking components (e.g., host firewalls).

Deployment Models are as follows: Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises. Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

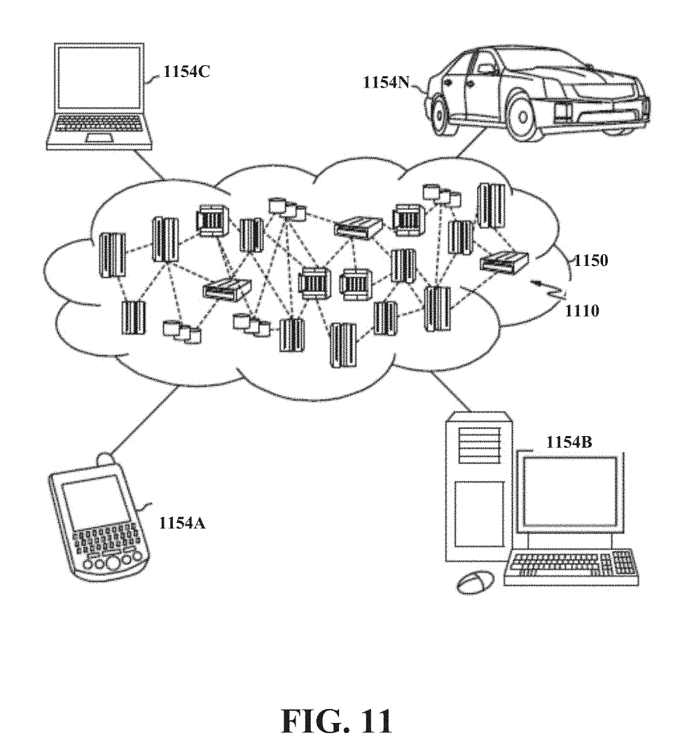

Referring now to FIG. 11, illustrative cloud computing environment 1150 is depicted. As shown, cloud computing environment 1150 includes one or more cloud computing nodes 1110 with which local computing devices used by cloud consumers, such as, for example, personal digital assistant (PDA) or cellular telephone 1154A, desktop computer 1154B, laptop computer 1154C, and/or automobile computer system 1154N may communicate. Nodes 1110 may communicate with one another. They may be grouped (not shown) physically or virtually, in one or more networks, such as Private, Community, Public, or Hybrid clouds as described hereinabove, or a combination thereof. This allows cloud computing environment 1150 to offer infrastructure, platforms and/or software as services for which a cloud consumer does not need to maintain resources on a local computing device. It is understood that the types of computing devices 1154A-N shown in FIG. 11 are intended to be illustrative only and that computing nodes 1110 and cloud computing environment 1150 can communicate with any type of computerized device over any type of network and/or network addressable connection (e.g., using a web browser).

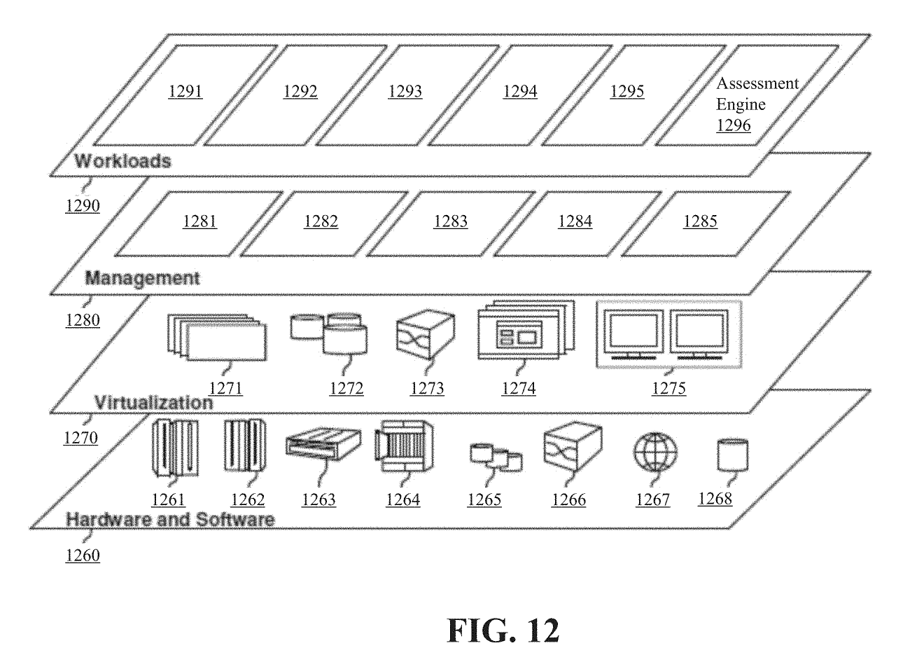

Referring now to FIG. 12, a set of functional abstraction layers provided by cloud computing environment 1150 (FIG. 11) is shown. It should be understood in advance that the components, layers, and functions shown in FIG. 12 are intended to be illustrative only and embodiments of the invention are not limited thereto. As depicted, the following layers and corresponding functions are provided: Hardware and software layer 1260 includes hardware and software components. Examples of hardware components include: mainframes 1261; RISC (Reduced Instruction Set Computer) architecture based servers 1262; servers 1263; blade servers 1264; storage devices 1265; and networks and networking components 1266. In some embodiments, software components include network application server software 1267 and database software 1268.

Virtualization layer 1270 provides an abstraction layer from which the following examples of virtual entities may be provided: virtual servers 1271; virtual storage 1272; virtual networks 1273, including virtual private networks; virtual applications and operating systems 1274; and virtual clients 1275.

In one example, management layer 1280 may provide the functions described below. Resource provisioning 1281 provides dynamic procurement of computing resources and other resources that are utilized to perform tasks within the cloud computing environment. Metering and Pricing 1282 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1283 provides access to the cloud computing environment for consumers and system administrators. Service level management 1284 provides cloud computing resource allocation and management such that required service levels are met. Service Level Agreement (SLA) planning and fulfillment 1285 provide pre-arrangement for, the procurement of, cloud computing resources for which a future requirement is anticipated in accordance with an SLA.

Workloads layer 1290 provides examples of functionality for which the cloud computing environment may be utilized. Examples of workloads and functions which may be provided from this layer include: mapping and navigation 1291; software development and lifecycle management 1292; virtual classroom education delivery 1293; data analytics processing 1294; transaction processing 1295; and assessment engine 1296.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create method for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible embodiments of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative embodiments, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other method to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” “data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
matching, by a system operatively coupled to a processor, input data retained in a knowledge source database to an inquiry included in a received questionnaire, wherein the input data is associated with a target entity; and
generating, by the system, a response to the inquiry based on the input data retained in the knowledge source database and a feature value that specifies a defined form of the response, wherein the response is based on an applicability of the input data to the target entity, and wherein the generating is based on machine learning applied to information retained in the knowledge source database.

2. The computer-implemented method of claim 1, wherein the inquiry is a first inquiry, the response is a first response, and the feature value is a first feature value, the computer-implemented method further comprising:
matching, by the system, the input data retained in the knowledge source database to a second inquiry included in the received questionnaire; and
generating, by the system, a second response to the second inquiry based on the input data and a second feature value for the defined form of the second response, wherein the first feature value and the second feature value are different feature values, and wherein the generating the second response comprises transforming a previous response comprising a third feature value to a format comprising the second feature value.

3. The computer-implemented method of claim 2, further comprising:
generating, by the system, a score value based on the first response and the second response, and based on a score formula defined for the received questionnaire.

4. The computer-implemented method of claim 1, wherein the generating the response to the inquiry comprises formulating the response based on the feature value that includes a restriction defined for a format of the response.

5. The computer-implemented method of claim 4, wherein the restriction is selected from a group consisting of a Boolean response, a text response, a numerical response, and a categorical response.

6. The computer-implemented method of claim 1, wherein the target entity is a first target entity and, based on a determination of an absence of input data related to the target entity being retained in the knowledge source database, the determining the response to the inquiry comprises evaluating, by the system, a second response from a second target entity, wherein the first target entity and the second target entity are determined to be related based on a first profile of the first target entity and a second profile of the second target entity, and wherein the first profile and the second profile are determined to have a feature having a defined level of similarity.

7. The computer-implemented method of claim 1, wherein the matching the input data retained in the knowledge source database to the feature value comprises semantically expanding a defined answer to a previous query, and wherein the matching the input data to the feature value comprises matching the input data that comprises scalable data without a corresponding decrease in a processing efficiency of the system.

8. The computer-implemented method of claim 1, further comprising assigning, by the system, a confidence score to the response, wherein the confidence score is based on the applicability of the response to the target entity.

9. The computer-implemented method of claim 1, further comprising:
evaluating, by the system, a relevancy of an assessment for the target entity based on the response to the inquiry; and
facilitating, by the system, a selection of the assessment from one or more assessments based on a determination that the relevancy satisfies a defined condition, wherein the assessment is the received questionnaire.

10. The computer-implemented method of claim 1, wherein the knowledge source database comprises an electronic text corpus associated with the target entity.

11. The computer-implemented method of claim 1, wherein the knowledge source database comprises a global domain knowledge database and a specific knowledge database, wherein the global domain knowledge database comprises structured electronic information and unstructured electronic information and the specific knowledge database comprises an electronic profile for the target entity.

12. The computer-implemented method of claim 1, wherein the target entity is a patient, the knowledge source database is a medical record, and the received questionnaire is a medical questionnaire.
